(19) United States
(12) Patent Application Publication
(10) Pub. No.: US 2009/0190378 A1
(43) Pub. Date: Jul. 30, 2009

(54) POWER SUPPLY DEVICE OUTPUTTING PULSED ELECTRICAL CURRENT

(76) Inventors: Hideo Ishii, Osaka (JP); Tetsuro Ikeda, Osaka (JP); Kenzo Danjo, Osaka (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/021,386

(22) Filed: Jan. 29, 2008

(51) Int. Cl. H02M 3/335

(52) U.S. Cl. 363/21.01

(57) ABSTRACT

The power supply device of the present invention which outputs pulsed electrical current includes an inverter which converts an input voltage to high frequency AC, a rectifier which rectifies the output of the inverter and converts it to DC, and an output polarity changeover unit which, via a reactor, alternatingly turns ON and OFF the output at a positive electrode side of the rectifier and the output at a negative electrode side thereof. Moreover, this power supply device includes a current transformer including a closed magnetic circuit or coil, pierced by a first output current line in which the current at the positive electrode flows, and by a second output current line in which the current at the negative electrode flows. The directions of piercing of the output current lines through the current transformer are set so that the directions in the current transformer, in which current flows in the first and second output current lines, are the same.

### BACKGROUND OF THE INVENTION

The present invention relates to a power supply device which outputs an electrical current in pulse form, with the polarity of the output current changing over alternatingly.

With a power supply device for arc welding or a power supply device for electroplating, the power supply device may be lightened by providing an inverter. For example, in the case of the power supply device described in Japanese Laid-Open Patent Publication Heisei 5-111244, there is proposed a power supply device for an arc welding machine which supplies, to an arc load, high frequency AC unchanged as AC, or converted to DC, comprising a rectifier which converts the AC power supply voltage to DC, a smoothing capacitor which smoothes this rectified output, and a high frequency switching circuit which converts this smoothed output to high frequency AC by ON/OFF control by a switching element.

Moreover, as shown in FIG. 1, a device has been proposed which comprises an output polarity changeover unit which changes over the polarity of the output current at high speed.

In FIG. 1, an AC power supply voltage which is inputted to input terminals 1A, 1B, and 1C is rectified by a rectifier 2. The rectified output is converted to DC voltage of a predetermined level by a voltage supply unit 3, and this DC voltage is supplied to a first reactor 4A and a second reactor 4B, and then, via a first switching element 5A and a second switching element 5B, is applied between a torch 6 and a base metal 7, which is a material to be welded. The voltage supply unit 32 comprises: an inverter 30 which switches the rectified output at high frequency, thus converting it to high frequency AC voltage; an inverter control circuit 31 which ON/OFF controls switching elements within the inverter 30; a transformer 32 which changes the voltage of the high frequency AC voltage; and rectification diodes 33A˜33D which rectify the output of the transformer 32.

The first switching element 5A and the second switching element 5B are ON/OFF controlled alternatingly at a predetermined frequency by a polarity command control circuit 8.

A current transformer 9 for current detection is provided between the torch 6 and a center tap 32T of the transformer 32 of the voltage supply unit 3. This current transformer 9 comprises a closed magnetic circuit or a coil pierced by the power supply line and connected to the torch 6 and to the center tap 32T, and the output of the current transformer 9 (the detected output current value) is outputted to the inverter control circuit 31 of the voltage supply unit 3.

With the power supply device shown in FIG. 1, it is possible to supply to the torch 6 a pulsed electrical current whose polarity is changed over alternatingly, by alternatingly ON/OFF controlling the first switching element 5A and the second switching element 5B with the polarity command control circuit 8. When this current is being supplied, the output current (the load current) is detected by the current transformer 9, and control of the switching elements within the inverter 30 is performed so that this current is kept constant.

Such a current transformer 9 has the advantage of being extremely cheap. However, as shown in FIG. 2, in the output of such a current transformer, the current value spikes at the ON/OFF timing of the first switching element 5A and the second switching element 5B. The reason that this type of phenomenon occurs is that the direction of the load current which flows in the current transformer 9 is reversed as the first switching element 5A and the second switching element 5B go ON and OFF. In other words, due to the self inductance of the current transformer 9, the output of the current transformer 9 swings over from plus polarity to minus polarity, or from minus polarity to plus polarity, at the timing at which the ON/OFF of the first switching element 5A and the second switching element 5B change over. Since this change is inputted to the inverter control circuit 31 just as it is without modification, accordingly the maximum value of the output current becomes io+ip at the above described changeover timing, as shown in FIG. 2, and a transient spike current flows. For example, if the rated output current io has a peak value of 200 amps, and the polarity change over is performed on a 10 μsec cycle, then the magnitude of the maximum value io+ip of the output current becomes more than 400 amps. Due to this, the current stresses upon the first switching element 5A and the second switching element 5B become extremely great, and it has been necessary to employ, for these elements, high cost switching components having rated characteristics of being able to withstand more than 400 amps, in order to prevent them being destroyed.

Thus, the present invention takes as its object to provide a low cost power supply device which outputs a pulsed electrical current, which can prevent the flow of transient spike currents when the polarity of the output current is changed over.

### SUMMARY OF THE INVENTION

The power supply device of the present invention which outputs pulsed electrical current includes: a first rectifier which converts an AC power supply voltage to DC; a smoothing condenser which smoothes the rectified output; an inverter which converts the smoothed output to high frequency AC by turning a switching element ON and OFF; a transformer which changes the voltage of the output of the inverter; a second rectifier which rectifies the output of the transformer; an output polarity changeover unit which, via a reactor, alternatingly turns ON and OFF the output current at a positive electrode of the second rectifier and the output current at a negative electrode thereof; and a current transformer including a closed magnetic circuit or coil, pierced by a first output current line in which the current at the positive electrode flows, and by a second output current line in which the current at the negative electrode flows. The directions of piercing of the output current lines through the current transformer are set so that the directions in the current transformer, in which current flows in the first and second output current lines, are the same.

In a preferred embodiment of the present invention: the reactor includes a first reactor which is connected in series with the positive electrode side output of the second rectifier, and a second reactor which is connected in series with the negative electrode side of the second rectifier; the output polarity change over unit includes a first switching element which is connected in series with the first reactor, and a second switching element which is connected in series with the second reactor; and the first output current line connects together the first reactor and the first switching element, and the second output current line connects together the second reactor and the second switching element.

### BRIEF DESCRIPTION OF THE DRAWINGS

FIG. 1 is a circuit diagram of a prior art power supply device which outputs a pulsed electrical current;

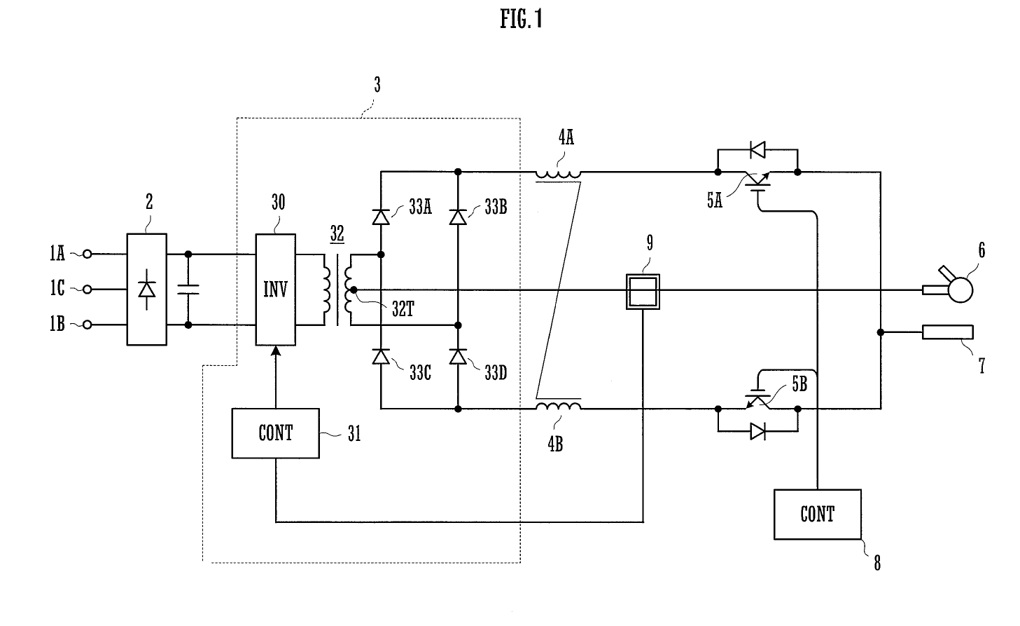

FIG. 2 is a figure showing the waveform of the output current of this prior art power supply device;

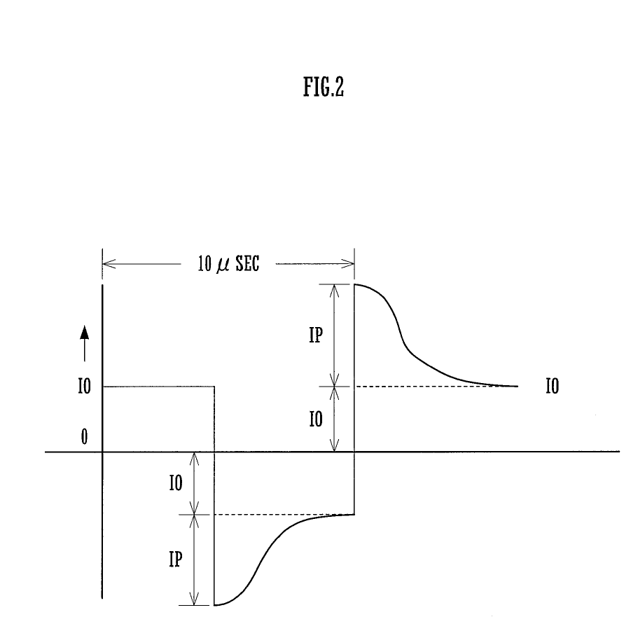

FIG. 3 is a circuit diagram of a power supply device which outputs a pulsed electrical current, according to an embodiment of the present invention;

FIG. 4 is a figure showing the direction of flow of a positive polarity output current, with this power supply device according to an embodiment of the present invention;

FIG. 5 is a figure showing the direction of flow of a negative polarity output current, with this power supply device according to an embodiment of the present invention; and

FIG. 6 is a figure showing the waveform of the output current of this power supply device according to an embodiment of the present invention.

### DETAILED DESCRIPTION OF THE INVENTION

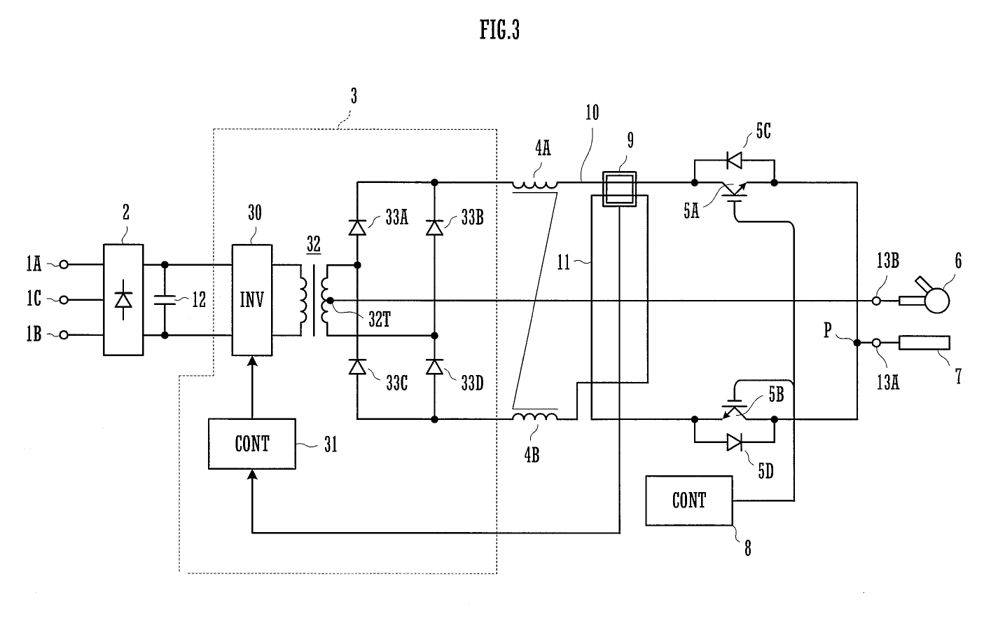

FIG. 3 is a circuit diagram of a power supply device, which is an embodiment of the present invention, and which outputs a pulsed electrical current.

Referring to FIG. 3, an AC power supply voltage which is inputted at input terminals 1A, 1B, and 1C is rectified by a rectifier 2 which converts it to DC. The rectified output is converted by a voltage supply unit 3 to a DC voltage of a predetermined voltage value. After rectification, the DC current at the positive electrode is supplied to a torch 6 and a base metal 7 via a first reactor 4A and a first switching element 5A. Moreover, after rectification, the DC current at the negative electrode is supplied to the torch 6 and the base metal 7 via a second reactor 4B and a second switching element 5B. The first reactor 4A and the second reactor 4B are made by winding a coil of the first reactor 4A and a coil of the second reactor 4B around the same magnetic core, so that the directions in which current flows in them are the same.

The voltage supply unit 3 comprises an inverter 30 which converts the rectified output to a high frequency AC voltage by switching it at high frequency, an inverter control circuit 31 which ON/OFF controls switching elements within the inverter 30, a transformer 32 which changes the voltage of the high frequency AC voltage, and rectification diodes 33A˜33D which rectify the output of the transformer 32.

The first switching element 5A and the second switching element 5B are ON/OFF controlled alternatingly at a predetermined frequency by a polarity command control circuit 8.

The torch 6 and the center tap 32T of the transformer 32 of the voltage supply unit 3 are directly connected together. A current transformer 9 is provided between the first reactor 4A and the first switching element 5a, and between the second reactor 4B and the second switching element 5B. An output current line 10 which connects together the first reactor 4A and the first switching element 5a, and an output current line 11 which connects together the second reactor 4B and the second switching element 5B, pierce through the closed magnetic circuit of the current transformer 9. Moreover, a detection coil is provided in the current transformer 9 so that the magnetic flux within this closed magnetic circuit pierces it, and this detection coil constitutes the output of the current transformer 9. The directions in which the two output current lines 10 and 11 pierce through the current transformer 9 are set so that so that the directions in the current transformer 9 of the DC current on the positive electrode side and of the DC current on the negative electrode side are the same. In other words, the output current line 10 pierces through the current transformer 9 so that the side of the first reactor 4A is positioned at the left side of the closed magnetic circuit of the current transformer 9, and the output current line 11 pierces through the current transformer 9 so that the side of the second reactor 4B is positioned at the right side of the closed magnetic circuit of the current transformer 9.

It should be understood that, instead of the closed magnetic circuit, it would also be possible to use a coil. In this case, the output of the coil itself becomes the output of the current transformer 9.

A diode 5C which is connected in parallel with the first switching element 5A and a diode 5D which is connected in parallel with the second switching element 5B are diodes for surge prevention. A smoothing condenser 12 is provided to the output of the rectifier 2. The output side of the first switching element 5A and the output side of the second switching element 5B are connected together at a connection point P. This connection point P is connected to a first load terminal 13A, to which the base metal 7 is connected. Moreover, the center tap 32T of the transformer 32 is connected to a second load terminal 13B, to which the torch 6 is connected.

The polarity command control circuit 8 turns the first switching element 5A and the second switching element 5B alternatingly ON and OFF every 10 μsec. And, based upon the detected value of the output current as detected by the current transformer 11, the inverter control circuit 31 controls the ON/OFF of the switching elements within the inverter 30 so as to keep the output current at the positive electrode side, or the output current at the negative electrode side, at a constant current.

Next, the operation will be explained.

When the AC power supply voltage is inputted, the rectified output which has been rectified by the rectifier 2 is converted to high frequency AC by the inverter 3, and is inputted to the transformer 32. This AC input voltage is voltage-changed to a predetermined voltage by the transformer 32. When the first switching element 5A is ON, the output current at the positive electrode side which is voltage-changed and outputted by the transformer 32 is converted to DC by the rectification diodes 33A˜33D and flows to the first reactor 4A, and accumulation of energy is performed therein. This output current at the positive electrode side which has flowed to the first reactor 4A passes through the current transformer 9, and is supplied to the connection point P via the first switching element 5A.

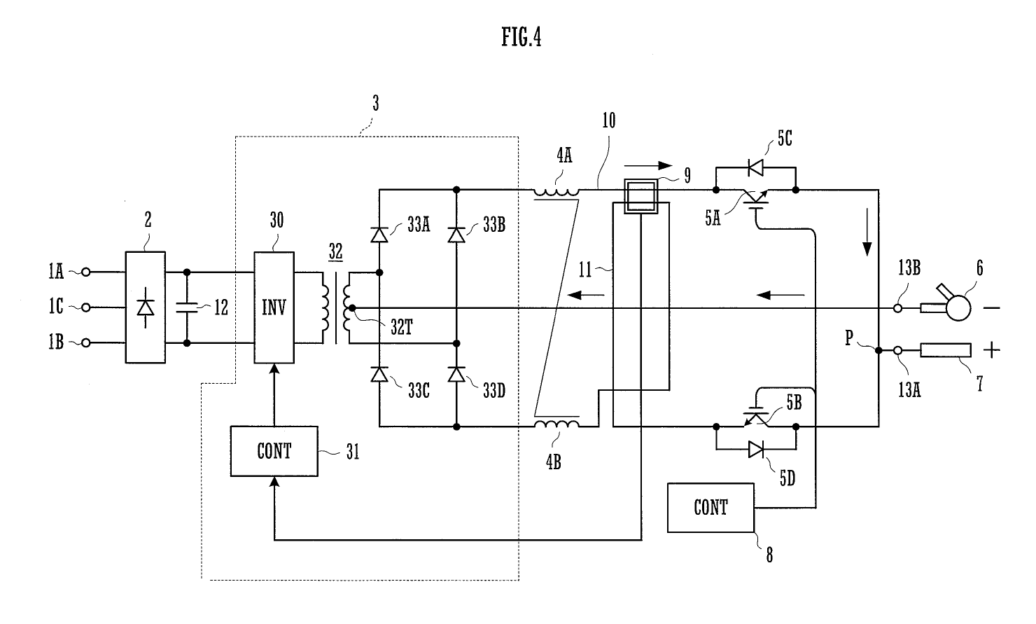

When an arc is generated between the torch 6 and the base metal 7, the output current at the positive electrode side is fed back to the center tap 32T of the transformer 32. FIG. 4 shows the direction in which the current flows at this time.

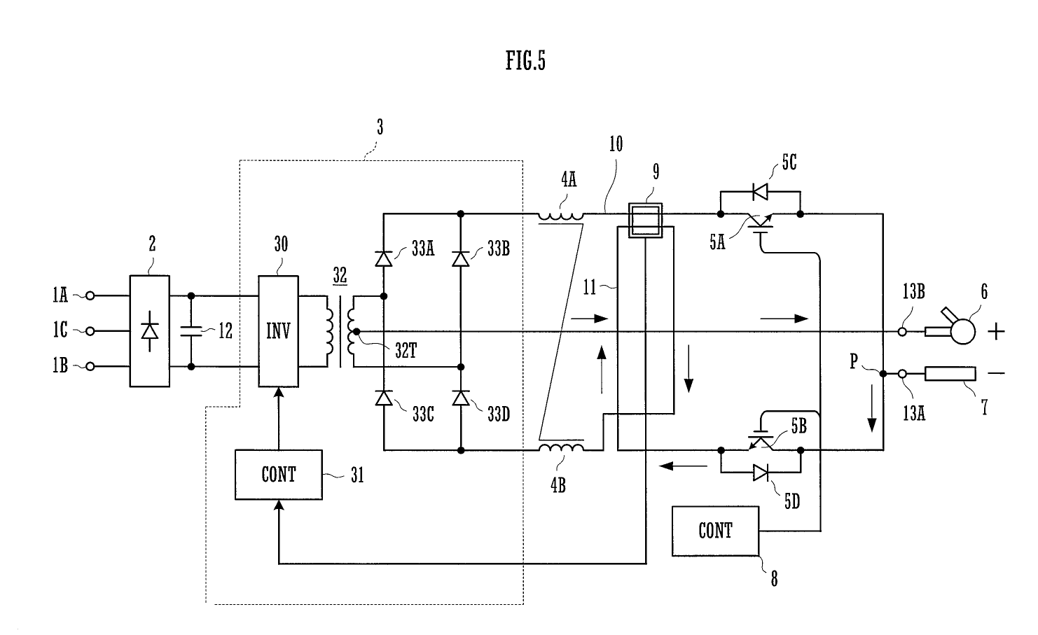

Next, the first switching element 5A is controlled by the polarity command control circuit 8 so as to be turned OFF, and moreover the second switching element 5B is controlled so as to be turned ON. When this is done, the output current at the negative electrode side which has been voltage changed by the transformer 32 and outputted is converted into DC by the rectification diodes 33A˜33D and flows to the second reactor 4B, and accumulation of energy is performed therein. This output current at the negative electrode side is supplied from the second load terminal 13B to the torch 6, and, when an arc is generated between the torch 6 and the base metal 7, this current returns back to the negative electrode side of the transformer 32 via the base metal 7, the connection point P, the second switching element 5B, the current transformer 9, and the second reactor 4B. FIG. 5 shows the direction in which the current flows at this time.

The above operation is repeated by controlling the first switching element 5A and the second switching element 5B alternatingly ON and OFF.

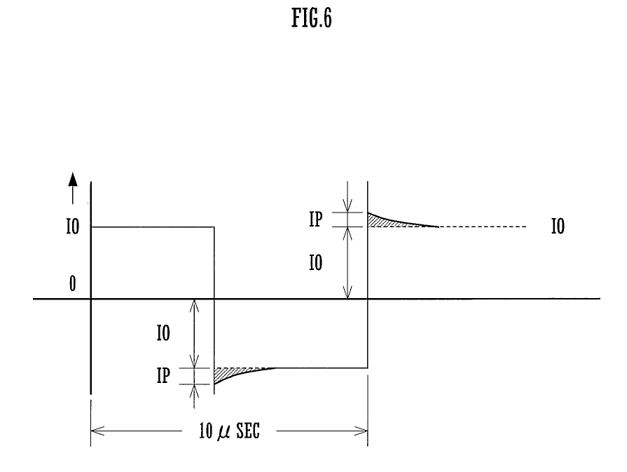

The directions in which the output current lines 10 and 11 pierce through the current transformer 9 are set so that the directions through the current transformer 9 of the DC current on the positive electrode side and of the DC current on the negative electrode side are the same. By doing this, the direction of the magnetic flux within the closed magnetic circuit of the current transformer 9 does not change at the timing at which the first switching element 5A and the second switching element 5B are changed over. In other words, the output of the current transformer is prevented from greatly shifting over from plus polarity to minus polarity, or from minus polarity to plus polarity, at the timing described above, due to transient phenomena caused by the self-inductance of the current transformer 9. As a result, as shown in FIG. 6, the magnitude of the spike DC current on the DC positive electrode side or on the DC negative electrode side at the timing at which the first switching element 5A and the second switching element 5B are changed over is extremely small. If the rated output current io is 200 amps at a 10 μsec cycle, then the magnitude of the spike current ip can generally be kept to be less than 20 amps.

Accordingly, it is not necessary to make the withstand voltage characteristic of the first switching element 5A and of the second switching element 5B large, so that it is possible to prevent increase of cost. Moreover, the current transformer 9 is extremely cheap in cost, since it can be made from a closed magnetic circuit and a coil.

The power supply device of the present invention is not only capable of being applied as a power supply device for arc welding; it could also be applied as a power supply device for electroplating.

What is claimed is:

1. A power supply device which outputs pulsed electrical current, comprising:
a first rectifier which converts an AC power supply voltage to DC;
a smoothing condenser which smoothes the rectified output;
an inverter which converts the smoothed output to high frequency AC by turning a switching element ON and OFF;
a transformer which changes the voltage of the output of said inverter;
a second rectifier which rectifies the output of said transformer;
an output polarity changeover unit which, via a reactor, alternatingly turns ON and OFF the output current at a positive electrode of said second rectifier and the output current at a negative electrode thereof; and
a current transformer comprising a closed magnetic circuit or coil, pierced by a first output current line in which the current at said positive electrode flows, and by a second output current line in which the current at said negative electrode flows,
wherein the directions of piercing of said output current lines through said current transformer are set so that the directions in said current transformer, in which current flows in said first and second output current lines, are the same.

2. A power supply device which outputs pulsed electrical current according to claim 1, wherein said reactor comprises a first reactor which is connected in series with the positive electrode side output of said second rectifier, and a second reactor which is connected in series with the negative electrode side of said second rectifier;
said output polarity change over unit comprises a first switching element which is connected in series with said first reactor, and a second switching element which is connected in series with said second reactor; and
said first output current line connects together said first reactor and said first switching element, and said second output current line connects together said second reactor and said second switching element.

3. A power supply device which outputs pulsed electrical current according to claim 2, wherein said transformer comprises a central tap; and
further comprising a load connection terminal between the connection point between the output side of said first switching element and the output side of said second switching element, and said center tap.
